(19) United States
(12) Patent Application Publication
(10) Pub. No.: US 2005/0067285 A1
(43) Pub. Date: Mar. 31, 2005

(54) Electrophoresis device

(76) Inventors: Ryoji Inaba, Hitachinaka (JP); Miho Ozawa, Abiko (JP); Akihiro Suzuki, Hitachinaka (JP); Daizo Tokinaga, Hachioji (JP); Tomohiro Shoji, Hitachinaka (JP); Yoshitaka Kodama, Hitachinaka (JP); Isao Haraura, Hitachinaka (JP); Masaya Kojima, Mito (JP)

Correspondence Address: DICKSTEIN SHAPIRO MORIN & OSHINSKY LLP, 2101 L Street, NW, Washington, DC, 20037, US

(21) Appl. No.: 10/913,517

(22) Filed: Aug. 9, 2004

(30) Foreign Application Priority Data
Sep. 19, 2003 (JP) 2003-327044

(51) Int. Cl. G01N 27/453

(52) U.S. Cl. 204/601; 204/603

(57) ABSTRACT

The present invention is related to the decrease of crosstalk, in which part of light emission from a specific capillary is overlayed on the light emission position of its adjoining capillaries and is detected as signal from adjacent capillaries. Study conducted by the inventor has found that the crosstalk contains at least the following components. The signal light from a capillary may propagate through an adjoining capillary or a plurality of capillaries, the reflection at the inner surface of the outer diameter of quartz capillary makes plural signal paths to the photodetector. The crosstalk component may be focused at a point at a predetermined distance from the center axis of the capillary. The present invention is aimed at the control of the range of image to be detected as the capillary signal among the images focused on the photodetector from the capillaries. The present invention may decrease the crosstalk by controlling the detection of the light emission from the adjacent capillaries.

### FIELD OF THE INVENTION

The present invention relates to an electrophoresis device, more specifically to an electrophoresis device for isolating and analyzing specimens such as fluoroluminescent labeled DNAs by means of electrophoresis.

### BACKGROUND OF THE INVENTION

To determine the sequence and length of the nucleotides in a DNA, the capillary electrophoresis has been used with polymer-coated quarts capillaries. The capillary electrophoresis is performed by injecting a sample to be analyzed into an isolation medium such as a polyacrylamide in the quartz capillary, then applying an electrophoresis voltage across the ends of the capillary. The DNA samples are isolated, migrating through the capillary according to the potential and molecular characteristics such as molecular weights, resulting in DNA bands in the capillary. Each of DNA bands, which are bound to a specific fluorescence dye, emits fluorescence of specific wavelength in response to the irradiation of laser beam, and the fluorescence thereof may be read by a fluorescence measuring means to determine the DNA sequence. The isolation and analysis of a protein can be performed in a similar manner to identify the protein.

The irradiation methods of laser beam include the multifocal method, which is as follows: in the multifocal method, in an array of a plurality of capillaries placed in parallel on a plane substrate, the laser beam is emitted to the capillary at one end or both to propagate the beam to the adjoining capillary sequentially to reach to the other end. At or about the position to be radiated by the laser beam the polyimide coat on the surface of the capillary will be removed, and the quartz surface of the capillary is interfaced with the ambient air. Since the laser beam passes through a plurality of capillaries that are placed in contact with other capillaries, the light emission from the capillaries and the laser beam will be reflected irregularly on the surface of each of capillaries. In addition, the irregular reflection will be further promoted by the plane substrate for placing the capillaries thereon.

In the patent document of JP-A 296235/2002, the diffused reflection is suppressed by forming a through hole on the area just behind the capillaries on the plane substrate when viewing the capillary array from the light detector side, in order to suppress the reflection of the diffused light by the substrate.

### SUMMARY OF THE INVENTION

In the electrophoresis, there is a problem that part of light emission from a specific capillary is overlayed on the light emitting position of its adjoining capillaries. In other words, the signal from the specific capillary may be detected as the signal from adjoining capillaries, or crosstalked. The present invention has been made in view of the above circumstances and has an object to overcome the above problem and to provide a decrease of crosstalk.

The inventor has thoroughly studied the crosstalk and found that the crosstalk contains at least the following components. The signal light from a capillary may propagate through an adjoining capillary or a plurality of capillaries, the reflection at the inner surface of the outer diameter of quartz capillary makes plural signal paths to the photodetector. The crosstalk component may be focused at a point at a predetermined distance from the center axis of the capillary.

The present invention is related to the control of the range of image to be detected as the capillary signal among the images focused on the photodetector from the capillaries. The present invention may decrease the crosstalk by controlling the detection of the light emission from the adjacent capillaries.

In addition the present invention is also related to the electrophoresis, allowing selecting either the lower crosstalk mode, which considers a priori the decrease of crosstalk rather than the improved signal-to-noise ratio (S/N), or the sensitive mode, which considers the improvement of S/N rather than the decrease of crosstalk. In accordance with the electrophoresis method of the present invention, the electrophoresis can be suitably applied to various analyses. The electrophoresis can be most suitably performed in accordance with the present invention in the reading of genetic code, and in the comparison of intensity of two DNA bands.

The present invention allows electrophoresis of samples to be performed in a high precision.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

It should be understood however that the accompanying drawings, which are incorporated in and constitute a part of this specification illustrate an embodiment of the invention and, together with the description, serve to explain the objects, advantages and principles of the invention, and not to be considered to limit the scope of the invention.

### BRIEF DESCRIPTION OF THE DRAWINGS

In the drawings,

FIG. 1 is the overview of a multi-capillary electrophoresis device in accordance with a first preferred embodiment of the present invention;

FIG. 2 is the schematic diagram of the fluorescence imaging element and CCD in accordance with the first preferred embodiment of the present invention;

FIG. 3 is the frontal view (a), and side views (b, c) of the photodetector in accordance with the first preferred embodiment of the present invention;

FIG. 4 is the schematic diagram of light paths of crosstalk;

FIG. 5(a) is the schematic diagram of an image on the CCD detector, (b) is an enlarged view of the vicinity of the rectangle in (a), and (c) is the distribution of intensity on the baseline of (a) and (b);

FIG. 6 is the schematic diagram of crosstalk;

FIG. 7 is the schematic diagram of crosstalk;

FIG. 8 is the schematic diagram illustrating the screen display on a personal computer for controlling the electrophoresis;

FIG. 9 is an example measurement in the sensitive mode; and

FIG. 10 is an example measurement in the low crosstalk mode.

### DETAILED DESCRIPTION OF THE PREFERRED EMBODIMENTS

A detailed description of one preferred embodiment embodying the present invention will now be given referring to the accompanying drawings.

When the electrophoresis device uses the illumination method by irradiating the laser beam to one or both extreme capillaries of an array of a plurality of capillaries placed in parallel and in contact with each other on a plane substrate to propagate the laser beam from the extreme capillary to its adjoining one and therefrom to the adjacent one and so on to across the array and by detecting the light emission from the array of capillaries with a photodetector, a two-dimensional CCD detector is used in general for detecting simultaneously the spectra of light emission from a plurality of capillaries. The vertical or ordinate axis (Y axis) of the two-dimensional image indicates the space, or the position of a plurality of capillaries. The abscissa or horizontal axis (X axis) of the two-dimensional image indicates the wavelength distribution, or the spectra of light emission from each of capillaries.

Due to the characteristics of light paths, which may cause the crosstalk, the position of crosstalk observed on an adjacent capillary (capillary B) is slightly outward of the center axis of the capillary B with respect to the original capillary (capillary A) of the emerging fluorescence. This implicates the possibility of spatial separation of the emerging or original fluorescence from within the capillary B from the light emission of crosstalk by the capillary B. In order to isolate the fluorescence spatially, the following method can be used. More specifically, the light intensity of the image focused on one single pixel in the Y-axis direction (the pixel at the center position of the capillary B) is recorded as the emission signal from the capillary B. The ratio of (crosstalk intensity)/(original emission signal intensity) in this case may be less than the case where the emission intensity of light focused on a plurality of pixels in the Y axis direction (the pixel at the center position of the capillary B and its surrounding pixels) is recorded as the emission signal from the capillary B. This means that the larger the distance is from the center position of the capillary B the larger the signal intensity of crosstalk as have been described above, hence the weaker the intensity of emanating signal emission from the capillary B is relatively. Therefore, the crosstalk can be minimized by recording only the signal at the one single pixel in the direction of capillary as the signal emanating from that capillary.

There also are alternative methods for minimizing the crosstalk. For example, by taking into consideration the fact that the crosstalk is derived from the reflection on the inner surface of the diameter of tube, the crosstalk can be decreased by enlarging the spatial isolation between the crosstalk fluorescence and the original fluorescence emanating from the sample within that capillary. The spatial distinction can be enlarged to decrease the crosstalk if the ratio of inner diameter/outer diameter of the quartz tube is smaller. However, when the ratio of inner diameter/outer diameter of the quartz tube is smaller, the loss of laser beam propagating through capillaries is larger due to the reflection. This indicates that the optimum condition setting should be found that might realize the trade-off conditions.

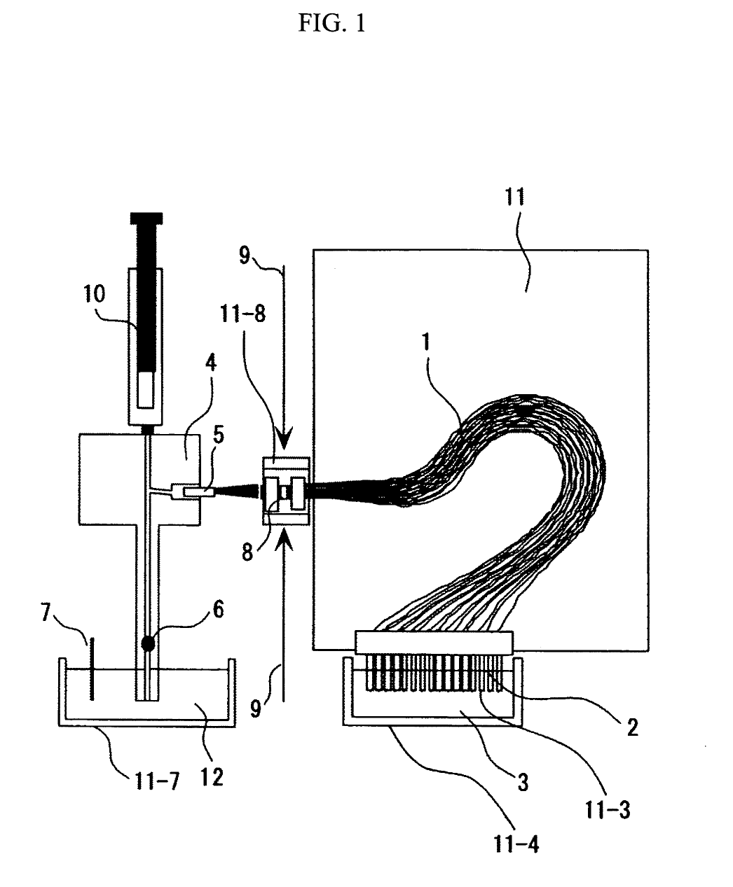

Now referring to FIG. 1, there is shown the overview of a multi-capillary electrophoresis device in accordance with a first preferred embodiment of the present invention.

The multi-capillary electrophoresis device in accordance with the preferred embodiment includes a multi-capillary array 1, formed of a plurality of capillaries each including isolation medium for isolating the specimen, a negative electrode 2 of the multi-capillary array, a specimen loader 11-3, buffer solution 3 which immerses the negative electrode 2 and specimen loader 11-3, a first buffer container 11-4 for containing the buffer solution 3, a gel block 4 having a valve 6, a ground electrode 7, buffer solution 12 for immersing the ground electrode 7 and the gel block 4, a second buffer container 11-7 for containing the ground electrode 7 for the ground electrode 7, a syringe 10 for injecting the gel that is the electrophoresis isolation medium into the capillary array, a detector unit 11-8 for acquiring information on the specimen, a light source (not shown in the figure) for emitting laser beam 9 that is coherent light to the light exposure unit 8, a measurement unit (not shown) for acquiring the fluorescence emanating from the specimen, an oven 11 for controlling the temperature of capillary array, and a high voltage power supply (not shown) for applying a voltage to the isolation medium.

The multi-capillary array 1 carries 48 quartz capillaries, each of which is filled with a sample specimen, which includes sample of DNA molecules, and the polymer solution, which is the isolation medium for isolating the DNA molecules contained in the sample. On one end of the multi-capillary array 1, the specimen loader 11-3 is formed for introducing the specimen into the capillaries, and the negative electrode 2 is placed for applying a negative voltage. On the other end a connector unit 5 is formed, which is connected to the gel block 4 to move the isolation medium from the gel block 4 to the multi-capillary array 1. The detector unit 11-8 including the light exposure unit 8 for irradiation of the laser beam is placed between the specimen loader 11-3 and the connector unit 5.

The gel block 4 and the syringe 10 form the flowable medium injection mechanism, which injects the electrophoresis isolation medium, the polymer solution into the capillaries. When injecting the polymer solution used as the electrophoresis medium into the capillaries, the valve 6 is closed and the syringe 10 is pressed to inject the polymer solution in the syringe 10 into the capillaries.

The multi-capillary array 1, gel block 4, buffer solution 3, negative electrode 2, buffer solution 12 for the ground electrode, ground electrode 7, and the high voltage power supply form the voltage application mechanism for performing the electrophoresis of sample. When conducting the electrophoresis, the negative electrode 2 is immersed into the buffer solution 3, and the valve 6 is opened. This forms an electric circuit passing through the negative electrode 2, buffer solution 3, multi-capillary array 1 (more specifically the polymer solution in the capillaries), gel block 4 (more specifically the polymer solution in the gel block), buffer solution 12 for the ground electrode, then to the ground electrode 7. A voltage is applied to the circuit from the high voltage power supply. When the voltage is applied to the circuit, the sample in the polymer solution migrates as electrophoresis and the components in the sample are separated depending on the difference of for example the molecular weight.

The optics of the electrophoresis device includes a light source, the detector unit 11-8 including the light exposure unit 8, and the detecting mechanism for detecting the fluorescence emanating from the exposure unit. The light source supplies the oscillation of a coherent laser beam 9 (the beam of 488.0 nm and 514.5 nm produced with the Argon Ion laser). The detector unit 11-8 houses plural light exposure units 8 in parallel for allowing the laser beam 9 to pass through the capillaries. The laser beam 9 is then introduced from both upper side and lower side to the detector unit 11-8 in order to pass through each light exposure unit 8 of a plurality of capillaries. The laser beam 9 excites the sample, and the excited sample emits the fluorescence. The fluorescence is detected by the detection mechanism including the CCD 34, to obtain information on the sample about the sequence of DNA molecules and the like. The light exposure to the capillaries can be the multi-focus type as shown in this embodiment, or any one of alternative methods including the scan method, expanded light irradiation method, and the like. The scan method uses for example a galvano-mirror to deflect the direction of laser beam, or moves a mirror for reflecting the laser beam to switch the capillary to be irradiated by the laser beam in the time-division basis. The expanded light irradiation method uses a planar beam that is expanded in a row as the exciting light to irradiate a plurality of capillaries at the same time.

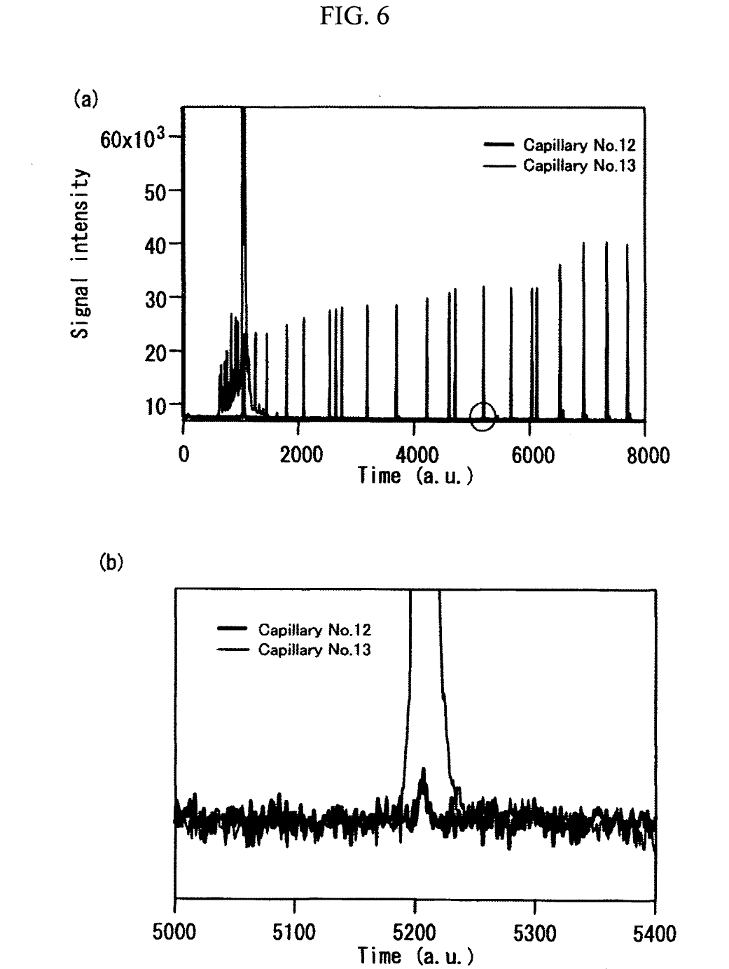

FIG. 6 shows the output from two capillaries, numbered as 12 and 13. The abscissa axis indicates the electrophoresis time. The capillary #13 contains a sample, while the capillary #12 does not. As shown in (b), the signal from the capillary #12 is the crosstalk of the signal of the capillary #13.

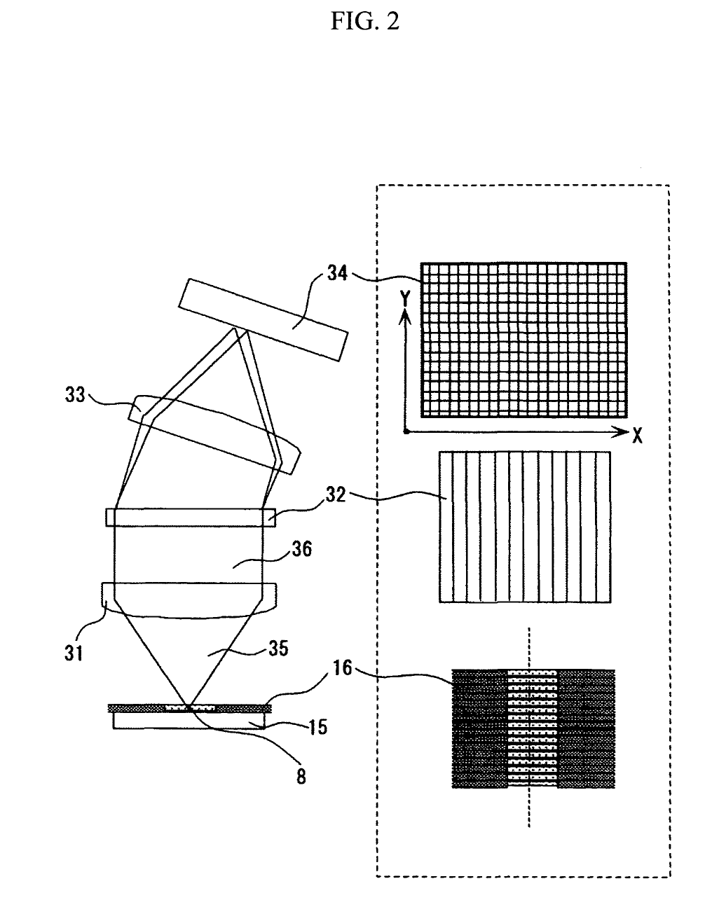

FIG. 2 shows the detecting mechanism of the fluorescence from the analysis sample in the capillary array, and the light exposure unit 8. The detection mechanism includes a fluorescence collimating lens 31, a grating 32, a focusing lens 33, and a CCD 34. The fluorescence 35 from the sample in the capillary 16 emanating by the laser beam 9 to the light exposure unit 8, will be captured by the fluorescence collimating lens 31 to the parallel beam 36, dispersed by the grating 32, and focused by the focusing lens 33 onto the CCD 34. FIG. 2 illustrates in the right hand half the components (grating and CCD) for focusing. There are 48 capillary images in the Y-axis direction, and the fluorescence from each capillary is dispersed in the X-axis direction.

The oven 11 is the temperature controlling mechanism for controlling the temperature of the multi-capillary array 1. The oven 11 incubates the most of the multi-capillary array 1 to a predetermined temperature for example at 60° C.

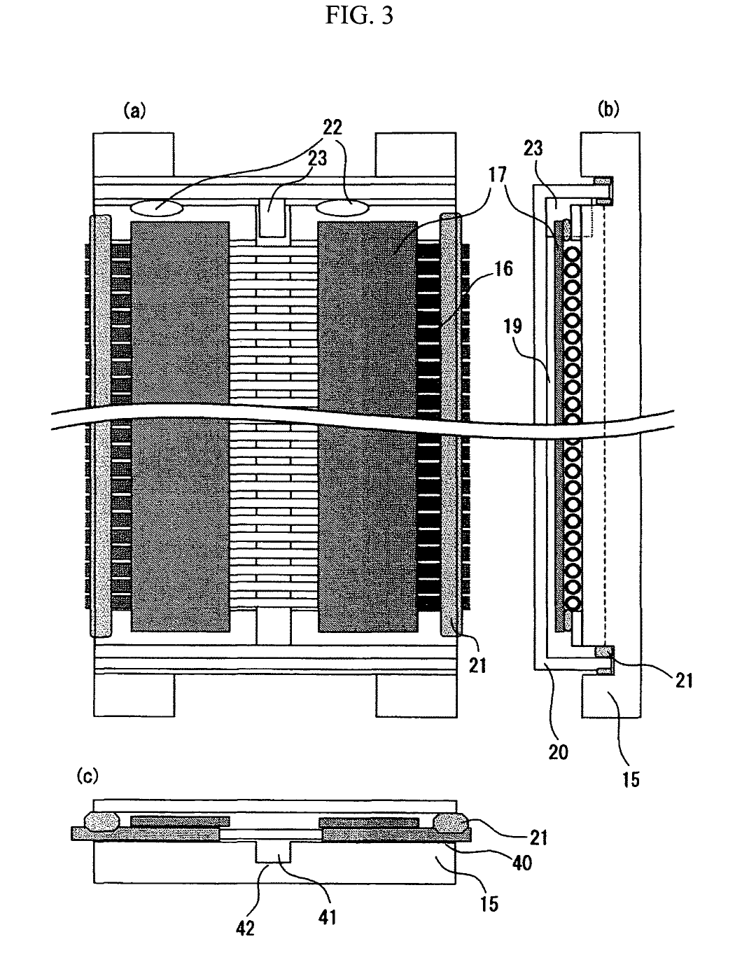

Now the detector unit 11-8 will be described. The frontal view (a) and the side views (b, c) of the detector unit 11-8 are shown in FIG. 3. The detector unit 11-8 includes 48 capillaries 16, the array substrate 15, a cell cover 20, a cover plate 17, an air-blocking block 23, transparent medium having a refractive index of 1.29 (F solution 19), and bubbles 22.

Now the disposition of capillaries will be described. In the multi-focus method a plurality of capillaries are served for propagation of laser beam, the relative misalignment between capillaries each other should be minimized. To achieve this, all capillaries are fixed by placing on and being pressed toward a planar substrate, each contacting with adjacent ones, so as to obtain the positional accuracy of the capillaries required for this method. More specifically, on the substrate 15 made of quartz, a reference plane 40 for disposing capillaries. 48 capillaries are disposed on the substrate 15 40 such that all capillaries contacts the reference plane 40 and adjoining two capillaries are in contact. The capillaries 16 are secured to the substrate 15 when nipped between the cover plate 17 for fixing the capillaries 16 and the substrate 15. The capillaries are placed in parallel in a plane to allow the relative deviation of the center axis of capillaries to be less than 6 micrometers. This results in a decrease of affected loss of the laser beam 9 by the refraction and reflection when emitting the laser beam 9 to pass through all 48 capillaries at the same time. The placement of capillaries may not be limited to the method as have been described above. For example, by using two members each having a plane for disposing and holding capillaries (for example, a planar substrate having holes at the center or concaved member), a plurality of capillaries are aligned in a plane such that both ends of the laser emission path are held while the zone where the laser beam is irradiated is not. The capillaries are not necessarily aligned with contacting each other. They can be apart if they are well aligned in a plane.

The structure of capillary will be described. A capillary 16 has a quartz tube of inner diameter of 50 micrometers and outer diameter of 126 micrometers, covered by a polymer film of 12 micrometers, with the total outer diameter of 150 micrometers. In the capillary polymer, solution used for the isolation medium of DNA (refractive index of 1.41) is filled. On the light exposure unit 8 the capillary has its polymer-coat removed, thus the capillary has its bare quartz tube exposed. When irradiating the laser beam 9, part of diffused light may enter into the polymer coat of the capillary to emanate the fluorescence from the polymer coat. However, the fluorescence from the polymer coat is blocked by the cover plate 17 so as not to reach to the measuring unit. This allows a higher precision analysis to be achieved with a higher SNR.

In the multi-focus method, the laser beam attenuates by the reflection at the interface of quartz when the laser beam passes through the quartz of the capillary. In the preferred embodiment, light transmission medium having a predetermined refractive index is filled between capillaries in order to alleviate the attenuation to suppress the laser beam loss. More specifically, a tightly sealed structure is formed by the substrate 15, the cell cover 20 of quartz and the adhesive 21 for bonding them to configure a sealed container (cell) that is capable of holding light transmittable medium for a specific liquid or solid matter. Filling the F solution 19 in the cell allows the space between capillaries to fill with the F solution 19, so that the laser beam passes through the solution. In other words, the light exposure unit 8 of the capillaries 16 is immersed in the F solution 19. In order to avoid the laser beam from touching the planar substrate, the reference plane 40 has the groove 41 formed thereon. The bottom 42 of the groove is frosted and in parallel to the array plane of the capillaries.

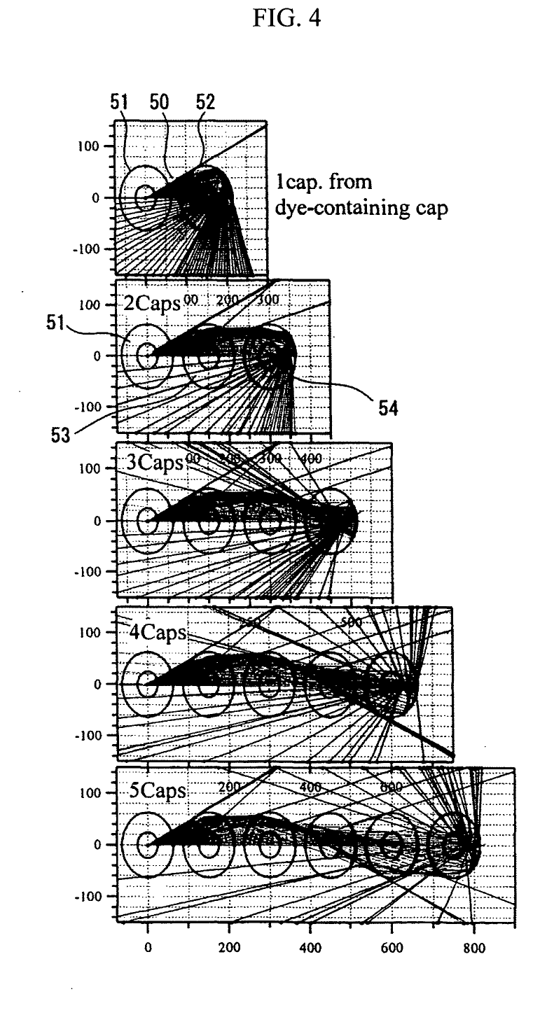

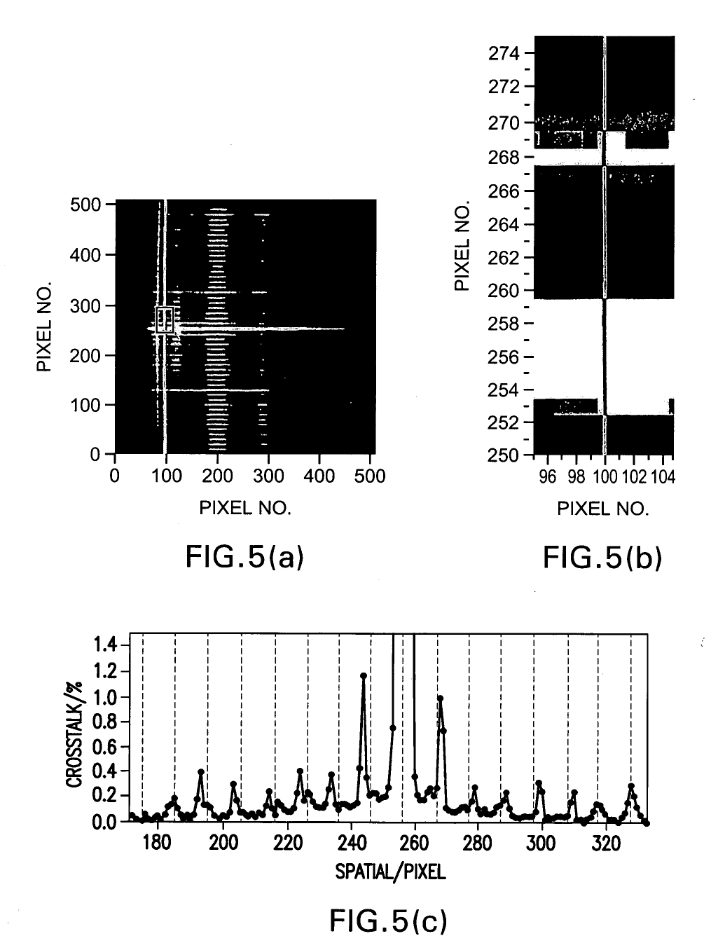

As shown in FIG. 4, the light emitted from a capillary 51 propagates to its adjacent capillaries 52 and 54; the inner wall of the outer diameter of the capillaries 52 and 54 reflects the light to introduce the light into the detector. The image on the CCD detector is shown in FIG. 5. The ordinate or vertical axis (Y axis) of the image indicates the space axis or the position of a plurality of capillaries. The abscissa or horizontal axis (X axis) is the wavelength diffusion axis, indicating the light emission spectrum of each capillary. FIG. 5 (b) shows an enlarged view of the vicinity of the rectangle shown in FIG. 5(a), and FIG. 5(c) shows the intensity distribution on the baseline shown in FIG. 5(a) and (b). The dotted line in FIG. 5(c) indicates the center position of capillaries. As can be seen from FIG. 5(c), the emanating position of crosstalk in the adjacent capillary (capillary B) is slightly outward of the center axis of capillary B with respect to the capillary originally emanating the fluorescence (capillary A). This proves that the crosstalk is caused by the light paths shown in FIG. 4.

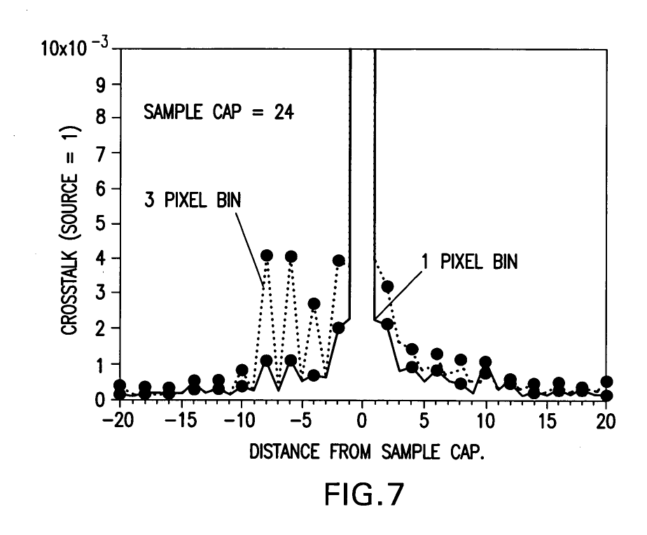

Data from three pixels in the direction of capillary array (FIG. 5(c): the center position of the capillary and one pixel in both sides) is recorded as the light emission signal from the capillary. FIG. 7 shows the crosstalk from the adjoining capillaries. The abscissa shows the distance, in the unit of the number of capillaries, from the capillary #24 into which the fluorescent emittable sample is injected. The ordinate or vertical axis indicates the amount of crosstalk, in the unit of % of crosstalk observed in the adjoining capillary. The crosstalk when integrating three pixels is shown as dotted line, the amount thereof reaches to 0.1% to 0.5%. The amount of crosstalk swings periodically. This corresponds to the periodic nature of the light intensity of the emission to the detector from the reflection from the inner wall of the outer diameter with respect to the distance from the capillary containing the sample.

Data only from one pixel in the capillary array direction (FIG. 5(c): only the center position of the capillary) can be recorded as the signal emanated from the capillary. The crosstalk in this case was in the range from 0.1% to 0.2% (solid line in FIG. 7). This indicates that the crosstalk is less when recording data only from one pixel wide in the direction of capillary array as the signal emanated from the capillary. However, the signal intensity is weaker when obtaining the signal for one pixel wide than obtaining data for three pixels. This results in a problem that the S/N ratio becomes smaller.

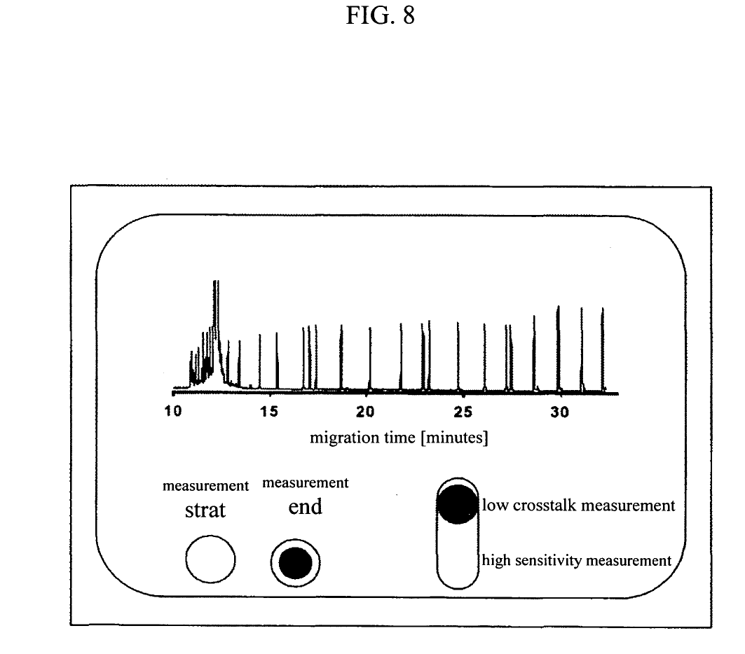

The present embodiment is also characterized in that it can switch the measurement mode on the display screen of the controlling software of the personal computer for the electrophoresis dev. FIG. 8 shows an example display screen of the controlling computer. There is a toggle switch for toggling the measuring mode between the low crosstalk measurement and high sensitivity mode, to switch the number of pixels to obtain data. In the low crosstalk mode, data only for one pixel in the direction of capillary array (FIG. 5(c): only the center position of the capillary) is recorded as the light emission signal emanated from the capillary. In the high sensitivity mode, data for three pixels in the direction of capillary array (FIG. 5(c): the center position of the capillary and the nearest one pixel in both sides) is recorded as the light emission signal emanated from the capillary. Mode switching can be done by mouse manipulation. The mode switching may be achieved by, not only the change of the number of pixel of data acquisition, but also by the selective enlargement of amplification power on the pixel at the center position of the capillary.

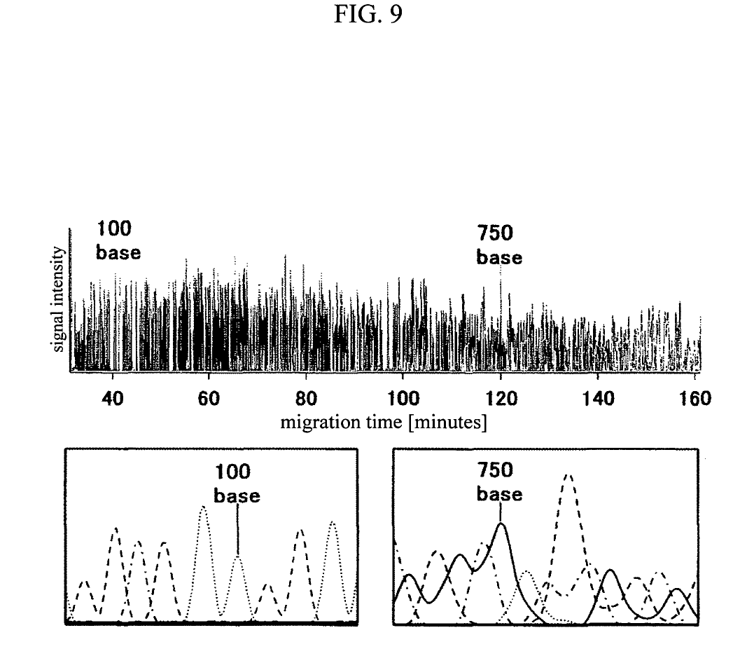

Now, FIG. 9 shows an exemplary measurement in the sensitivity mode. The measurement shown in FIG. 9 is a read-out of the genetic codes of human being. When reading the gene sequence the crosstalk less than approximately 0.5% may not arise a problem, since for each one nucleotide the fluorescence corresponding to any one of four base sequences should be always observed and the intensity of the crosstalk component in comparison to the intensity of main signal is sufficiently weak and neglectable. Important is the separation of each one base sequence. As can be seen in the 750th base shown in FIG. 9, the separation of one single base means identifying each peak from another peak and dip between the bands. Therefore, the sensitivity mode, in other words the acquisition of data for three pixels wide, having a larger SNR, is the suitable measurement mode.

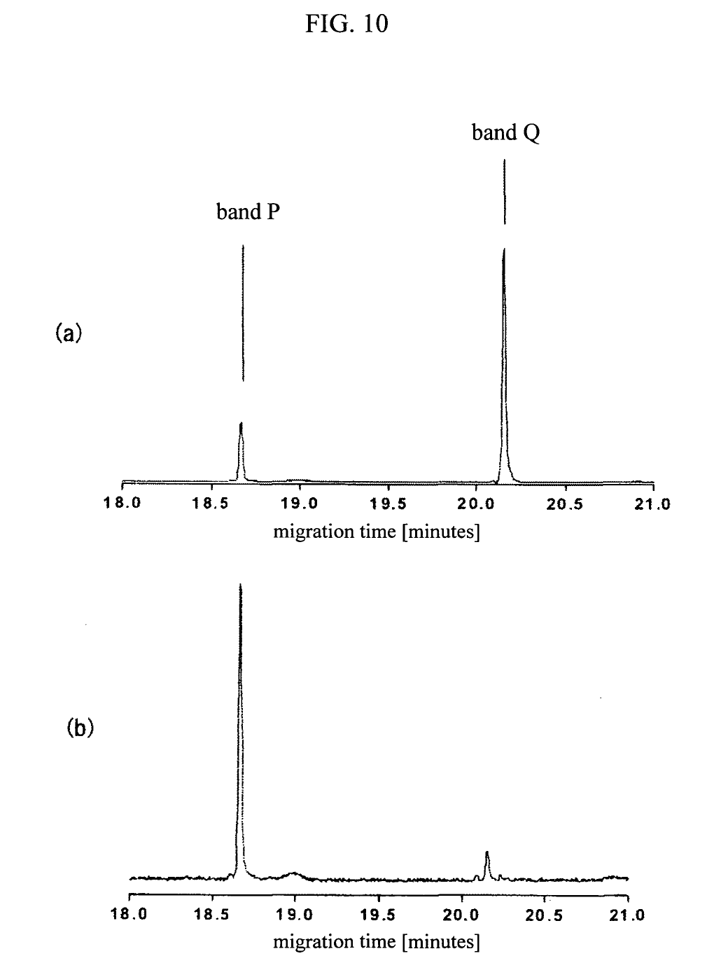

Now referring to FIG. 10, there is shown an exemplary measurement in the low crosstalk mode. The measurement example shown in FIG. 10 is a measurement of an emerging DNA of a tissue of two persons, in order to identify whether a gene code is emerged or not, based on the RNA that has emerged the gene expression. As the result of electrophoresis, two DNA bands, which have the interval of 50 bases, were observed. Then by determining the intensity ratio of those two bands, i.e., [intensity of the band Q]/[intensity of the band P] to either i) 1 or more, ii) 0.1 to 1, or iii) less than 0.1 to identify the presence or absence of the emerged gene expression. For (a), the intensity can be classified to i) 1 or more. However for (b), when there is a lot of crosstalk contamination in the measurement result, the result cannot be definitely determined whether that is exactly ii), or that may correspond to iii) because the peak apparently seen as the band Q could be crosstalk. On the other hand, (b) measured by the electrophoresis dev in the low crosstalk mode in accordance with the preferred embodiment, is ensured to be ii).

In the preferred embodiment, a mode switching between three pixels and one single pixel has been shown and described, however the number of pixels to be switched is not considered to be limited thereto. The mode switching can be achieved by switching between ten pixels and three pixels, or may be between ten pixels and some of ten except for those corresponding to the pixels having larger crosstalk as shown in FIG. 5(c).

In accordance with the preferred embodiment, it may be appreciated by those skilled in the art that one single electrophoresis device can analyse the sample at a higher accuracy for a wide variety of applications by toggling the mode between the low crosstalk mode and the sensitivity mode.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

It is further understood by those skilled in the art that the foregoing description is a preferred embodiment of the disclosed device and that various changes and modifications may be made in the invention without departing from the spirit and scope thereof.

1. An electrophoresis device, comprising:
an array of capillaries, including a plurality of capillaries to be filled with an electrophoresis medium, and a detection unit having at least some of said plurality of capillaries aligned on a plane; a power supply capable of applying a voltage across each of plurality of capillaries; a light source capable of emitting a laser beam to the detection unit; and a photodetector having a spatial axis corresponding to said plurality of capillaries in said detection unit, for acquiring the fluorescence emanated from a desired capillary by a single photodetector pixel in the direction of spatial axis.

2. An electrophoresis device set forth in claim 1, wherein:
said laser beam penetrates to said detection unit through one or both ends, and passes through said plurality of capillaries.

3. An electrophoresis device set forth in claim 1, wherein:
said capillary array includes a tightly sealed container, which may hold the light transmittable medium; and said detection unit is immersed in said light transmittable medium.

4. An electrophoresis device, comprising:
an array of capillaries, including a plurality of capillaries to be filled with an electrophoresis medium, and a detection unit having at least some of said plurality of capillaries aligned on a plane; a power supply capable of applying a voltage across each of plurality of capillaries; a light source capable of emitting a laser beam to the detection unit; a detector mechanism including a photodetector having a spatial axis corresponding to said plurality of capillaries in said detection unit, for acquiring the fluorescence by a photodetector pixel, and a controller unit for selecting the measurement mode of said photodetector; wherein said measurement mode includes a mode for acquiring the fluorescence from a desired capillary by using a single photodetector pixel in the direction of spatial axis, and a mode for acquiring the fluorescence from a desired capillary by a plurality of detector pixels in the direction of spatial axis.

5. An electrophoresis device set forth in claim 4, wherein:
said laser beam penetrates the detection unit through one or both ends thereof, and passes through a plurality of capillaries.

6. An electrophoresis device set forth in claim 5, wherein:
said capillary array includes a tightly sealed container, which may hold the light transmittable medium; and said detection unit is immersed in said light transmittable medium.

7. An electrophoresis device, comprising:
an array of capillaries, including a plurality of capillaries to be filled with an electrophoresis medium, and a detection unit having at least some of said plurality of capillaries aligned on a plane; a power supply capable of applying a voltage across each of plurality of capillaries; a light source capable of emitting a laser beam to the detection unit; and a detection mechanism including a photodetector capable of detecting the fluorescence from the detection unit, and a controller unit for selecting the measurement mode of said photodetector, wherein: said measurement mode includes a sensitivity mode for identifying the resolution of one base, and a low crosstalk mode having lower crosstalk than the sensitivity mode and a lower signal-to-noise ratio.

8. An electrophoresis device set forth in claim 7, wherein:
the crosstalk in said low crosstalk mode is approximately less than 0.5%.

9. An electrophoresis device set forth in claim 7, wherein:
said photodetector unit includes a plurality of photodetector pixels, and selects said measurement mode by changing the photodetector pixels for detecting the fluorescence from desired capillaries.

10. An electrophoresis device set forth in claim 7, wherein:
said photodetector unit includes a plurality of photodetector pixels, and selects said measurement mode by modifying the amplification power of predetermined photodetector pixels.
